(19) United States
(12) Patent Application Publication
(10) Pub. No.: US 2007/0061407 A1
(43) Pub. Date: Mar. 15, 2007

(54) Setting distribution in a home network

(75) Inventor: Eduard Gerhard Zondag, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindohoven (NL)

(21) Appl. No.: 10/570,847

(22) PCT Filed: Aug. 26, 2004
(86) PCT No.: PCT/IB04/51576

§ 371 Date: Mar. 6, 2006

(30) Foreign Application Priority Data
Sep. 12, 2003 (EP) 03103367.3

(51) Int. Cl. G06F 15/16

(52) U.S. Cl. 709/217

(57) ABSTRACT

Method for distributing data, in particular settings, between devices of a network. Data may be entered into any of the devices of the network, and the method is robust against dynamic addition or removal of devices. All devices are provided with a unique identification and have the same view of the network. Data entered into a first device is routed to a ‘primary device’ which then distributes the data to all of the other devices. The first device is the last to receive the data in the distribution step, thereby allowing the first device to monitor the distribution procedure.

The present invention relates to distribution of data between devices which are connected in a network comprising two or more devices. More particularly, the present invention relates to distribution of settings between devices which are connected in a home network.

Consumer Electronics (CE) devices, such as TVs, VCRs, stereo sets, personal computers, etc., are getting more and more clustered into home networks. It is therefore desirable that these devices are able to share various types of data, in particular data relating to settings which have, e.g., been entered into a device by a user. However, if a device is disconnected from the network, data entered to this device may get lost to the remaining devices. This is a great disadvantage.

U.S. Pat. No. 6,466,971 discloses a method and a system for command and control among a plurality of devices via a network. Application interface description data for commanding and controlling a second device is provided by the second device to a first device over the network. Subsequently, the first device sends control and command data to the second device in order to control the operation of the second device from the first device and over the network.

It is also known to copy channel-program number bindings from a TV to a VCR. This prevents the user from having to re-enter this setting in the VCR after the user has already done so for the TV.

It is an object of the present invention to provide a method for distributing data between devices in a network in such a way that data entered at any device of the network is distributed to all of the other devices.

It is a further object of the present invention to provide a method for distributing data between devices in a network, the method being robust against dynamic addition of removal of devices in the network.

It is an even further object of the present invention to provide a method for making data entered at one device of a network available to all other devices of the network in such a way that the data is not lost if a device is disconnected from the others.

It is an even further object of the present invention to provide a method for distributing settings between devices of a home network, the method being robust against addition and removal of devices in the network.

According to a first aspect of the present invention, the above and other objects are fulfilled by providing a method for distributing data between devices in a network connecting at least two devices, each device being provided with a unique identification, the method comprising the steps of:

entering data in a first device of the at least two devices,

identifying a primary device,

in case said primary device is not said first device, routing the entered data to said primary device,

distributing the entered data to all of the other of the at least two devices via the network,

wherein the distributing step is initiated by the primary device, and wherein the first device is the last to receive the data, thereby indicating to it the completion of the data distribution.

According to a second aspect of the present invention, the above and other objects are fulfilled by providing a network connecting at least two devices, each device being provided with a unique identification, wherein:

a first device of the at least two devices comprises means for receiving data being entered into said first device,

the first device comprises means for identifying a primary device,

the first device comprises means for routing the entered data to said primary device in case said primary device is not the first device, and

the primary device comprises means for distributing the entered data to all of the other of the at least two devices via the network.

The devices may be any kind of devices which are suitable for being connected in a network. Preferably, at least one of the devices of the network is a Consumer Electronic (CE) device, such as a TV, a VCR, a stereo set, a personal computer, etc.

In the present context the term ‘unique identification’ should be understood as a number or a code which uniquely identifies each device within the network, i.e at most one device in the network has a specific unique identification. All devices of the network should be able to identify each of the other devices by means of their unique identifications. In case various types of devices are present in the network, devices may be provided with an identification within the type of device. However, in this case there should be a mapping of the identifications provided by the various types onto a ‘global’ (i.e. within the network) identification in order to ensure that every device of the network has a unique identification within the network. The unique identification may, e.g., be MAC addresses, IEEE 1394 Global Unique Identifiers (GUIDs), or any other suitable kind of unique identification.

The ‘primary device’ may be any of the devices of the network. However, all devices of the network should regard the same device as the primary device. Thus, the primary device should be selected among the devices based on certain criteria It may, e.g., be the device having the lowest unique identification, the highest unique identification, the device of a specific type having the lowest or highest identification, the only device of a specific type, etc. Thus, when a device identifies the primary device, it searches for the device which fulfills the given criteria

When the primary device has been identified, the entered data is routed to the primary device. However, in case the step of identifying the primary device results in identifying the first device to which the data was originally entered, it is of course not necessary to route the data to the primary device, since the data was entered directly into the primary device.

The primary device then distributes the data to all of the other devices, the first device being the last to receive the data back. When the first device receives the data, it will know that all of the other devices have received the data since it is the last to receive it. Thus, the first device can monitor that the distribution is performed correctly. If it does not receive the data back it will know that something went wrong. It may restart the procedure if it does not receive back the data within a specific time limit, or if it receives an indication of a change in the network.

It is an advantage of the present invention that data which are to be shared by all the devices of the network may be entered into any of the devices of the network. Thus, it is not necessary to enter all data into one or two specific device(s). Furthermore, a network according to the present invention is robust against dynamic addition and removal of devices, since the data is distributed to all of the devices. Thus, no data is lost when a device is removed from the network, and data may easily be distributed, by means of the method according to the present invention, to a new device which is added to the network.

The method may further comprise the steps of:

the first device detecting a network change before the distributing step has been completed,

restarting the routing step,

said restarting step being initiated by the first device.

A network change may, e.g., be the adding or removal of a device to/from the network. Alternatively or additionally, it may be the entering of new data. The user may, e.g., discover that the entered data are erroneous, and may therefore enter corrected data before the distribution has been completed. In this case, the first device may restart the procedure in order to stop the distribution of the erroneous data, and instead start the distribution of the corrected data.

Similarly, the method may further comprise the steps of:

the primary device detecting a network change before the distribution step has been completed,

restarting the distribution step.

The network changes may be as described above. However, in this case it is the primary device which detects the change. Preferably, the change is in this case the adding or removal of a device. It may even be the removal of the first device from the network, in which case it will not be able to monitor that the distribution is performed as it should be. It may therefore be necessary to provide for alternative ways of monitoring the process. In case the network change is the adding of a device to the network, the primary device may restart the distribution step in order to ensure that the added device receives the data like all the other devices of the network.

In a preferred embodiment the network is a home network, i.e. a network established in a private home and comprising a number of devices which are normally found in a home, e.g. personal computers, TVs, VCRs, stereo sets, etc. The network may, alternatively, be another kind of network, such as an office network, a car or other vehicle, a medical environment, etc. However, the network should only comprise a limited number of devices, such as not exceeding 50 devices, such as not exceeding 30 devices, such as not exceeding 20 devices, such as not exceeding 10 devices, in order to provide an efficient distribution of data to all devices. Furthermore, the network may or may not be geographically confined. The network should also be of a kind in which all devices can be distinguished by a unique identification, and in which all devices have the same view of the network, such as an IEEE 1394 network.

The method may further comprise the steps of:

adding a device to the network,

said added device identifying the primary device,

said added device requesting the primary device for all available data.

In this embodiment a device which is added to the network makes sure that it gets all the data which is necessary and which is shared by the other devices of the network. This is done by identifying the primary device and requesting the primary device for all available data. Subsequently, the primary device will distribute the requested data to the added device. Since the primary device is the device which controls the distribution of data to all of the other devices of the network, it is natural for the added device to request all available data from the primary device. When data is entered into one of the devices, it will route the entered data to the primary device, and therefore one can assume that the primary device is in the possession of the most recent data.

In a very preferred embodiment the distributed data comprises at least one setting to be distributed between the at least two devices. The setting(s) may, e.g., be channel-program number bindings which have been entered into a TV or a VCR, and which are to be distributed to one or more other TV(s) and/or VCR(s) of the network. Alternatively or additionally, the setting(s) may be a default audio volume setting which is applicable to all amplifier devices of the network upon power-on. Furthermore, default recording devices for video or audio signals may be appointed to the network, in which case the setting(s) may comprise information regarding this.

The method may further comprise the steps of:

removing a device from the network,

the removed device removing all settings not entered by it-self.

When a device is removed from the network, it thus removes all settings which it has received via the network, i.e. settings which were originally entered into one of the other devices of the network and subsequently distributed to the device in accordance with the method of the present invention. When the device is no longer connected to the network it may not need settings which have not been entered directly into the device, and it is therefore practical that settings which relate to the network and/or which originate from one of the other devices of the network are removed when the device is no longer connected to the network. If the device is added to the network at a later time, it may request all available settings from the primary device, and receive all available settings, including any additions or updates which have been distributed in the meantime, in return. This way it is ensured that no old settings are left in a device which is added (or re-added) to the network.

Alternatively, the removed device may remove all of its settings. In this embodiment settings entered by the device itself as well as settings received from the other devices via the network are removed when a device is removed from the network. This may be advantageous in case settings entered by the device itself are actually related to the network, and which therefore have no meaning when the device is no longer connected to the network. Such settings may, e.g., be user specific printer settings entered into a personal computer. Such printer settings no longer make sense when the personal computer is no longer connected to the network, and hence no longer connected to the printer(s) of the network.

In one embodiment each entered setting may comprise type information, said type information indicating if a setting shall be distributed, in which case the method may further comprise the steps of:

reading said type information,

performing the identifying step, the routing step and the distributing step only if the type information indicates that the setting shall be distributed.

The entered setting may be very specific to the device to which it is entered, and it may therefore be irrelevant or inappropriate to distribute it to the other devices. Such settings may, e.g., be user-specific settings which should only be set in devices belonging to a specific user.

The distributed data may alternatively or additionally comprise at least one Uniform Resource Locator (URL) to be distributed between the at least two devices. It may, e.g., be a URL to a stable storage or Internet location comprising the actual data. In this case it is not necessary to distribute the actual data, thereby saving communication and storage overhead.

Alternatively or additionally, the data may comprise any other suitable kind of data, such as icons, domain names, parental control data, etc.

The data may comprise a label identifying the data, and a stamp, in which case the method may further comprise the steps of:

each device reading the label and the stamp when receiving the data, and

in case a device receives data having a label-stamp pair in which the label is identical to the label of a label-stamp pair of previously received data, assuming and using the data with the most recent stamp.

The stamp is preferably a time stamp. This embodiment may advantageously be used when an updated version of previously distributed data is distributed. The updated version will then have a time stamp indicating that it is a later version, and the devices will accordingly replace the older version with the updated version. In case a device for some reason is in the possession of a version of the data which is even more recent than the one being distributed, it will ignore the data being distributed, i.e. keep the later version which it already has. It may use the receipt of the older stamped data to route its more recent data to the primary device, thus properly updating the data in the network.

Alternatively or additionally, the stamp may contain information relating to other data which has previously been distributed. In this case the method may further comprise the step of removing specific data present in one or more device(s) in response to the device(s) receiving data having a stamp which is indicating that said specific data should be removed. Thus, obsolete or unwanted data may simultaneously be removed from all devices of the network which contain such data by distributing a “remove data” command to the devices.

The method may further comprise the step of providing a delay period before the distribution step is performed, said step being initiated by the primary device in response to receiving the data. This may be useful if the primary device has recently received and distributed some other data. In order to allow this previous data to be properly distributed before starting the distribution of the new data, it may be useful or necessary to introduce such a delay or ‘cooling off’ period. This also lowers the communication and processing overhead requirements of the network.

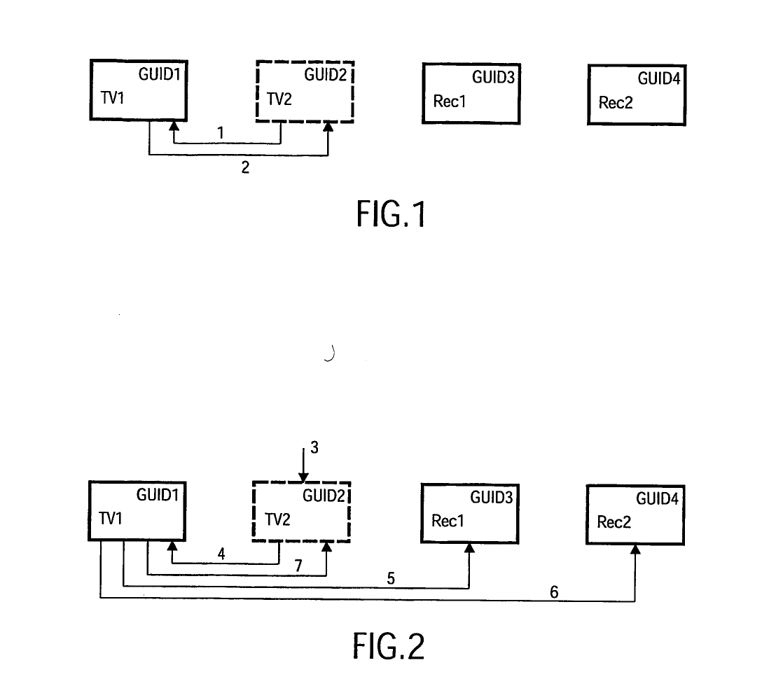

FIG. 1 shows distribution of settings in a network comprising three devices when a fourth device is added to the network, and

FIG. 2 shows distribution of entered settings between devices of a network comprising four devices.

FIG. 1 shows an IEEE 1394 network comprising three devices, a first TV (TV1), a first recorder (Rec1), and a second recorder (Rec2), each being provided with a Global Unique Identifier (GUID1, GUID3, GUID4).

A fourth device is added to the network. In the Figure, the fourth device is a second TV (TV2). TV2 is also provided with a Global Unique Identifier (GUID2).

Having been added, TV2 identifies the device of the network having the lowest unique identification, in this case TV1 (having GUID1). TV2 then requests 1 settings of the network from TV1. TV1 forwards 2 the settings to TV2. The forwarded settings comprise channel-program number bindings. These have preferably been distributed to Rec1 and Rec2 at an earlier time. Thus, when the procedure shown in FIG. 1 has been completed, all devices (TV1, TV2, Rec1, Rec2) of the network have received these settings.

FIG. 2 shows an IEEE 1394 network comprising the four devices described above in connection with FIG. 1 (TV1, TV2, Rec1, Rec2). A setting is entered 3 into TV2. TV2 then identifies the device having the lowest unique identification, in this case TV1 (having GUID1). Having identified TV2 as the device having the lowest unique identifier, TV2 sends 4 the setting to TV1. TV1 then forwards the received setting to all of the other devices of the network in the following way. First, the setting is forwarded 5 to Rec1, then it is forwarded 6 to Rec2, Rec2 having a higher unique identification than Rec1. Finally, the setting is forwarded 7 to TV2 which is the device to which the setting was originally entered. The device to which the setting was entered should always be the last to receive it back. When TV2 receives back the setting, it will therefore know that the distribution of the setting to the other devices of the network has been completed.

In case a change occurs before the distribution has been completed (i.e. before TV2 receives back the setting), TV2 may stop the procedure by sending a message to TV1. Such a change may, e.g., be one or more new setting(s) being entered into TV2.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality.

1. A method for distributing data between devices in a network connecting at least two devices, each device being provided with a unique identification, the method comprising the steps of:
entering (3) data in a first device of the at least two devices,
identifying a primary device,
in case said primary device is not said first device, routing (4) the entered data to said primary device,
distributing (5, 6, 7) the entered data to all of the other of the at least two devices via the network,
wherein the distributing step is initiated by the primary device, and wherein the first device is the last to receive the data, thereby indicating to it the completion of the data distribution.

2. A method according to claim 1, wherein the primary device is the device having the lowest unique identification.

3. A method according to claim 1, further comprising the steps of:
the first device detecting a network change before the distributing step has been completed,
restarting the routing step,
said restarting step being initiated by the first device.

4. A method according to claim 1, further comprising the steps of:
the primary device detecting a network change before the distribution step has been completed,
restarting the distribution step.

5. A method according to claim 1, wherein the network is a home network.

6. A method according to claim 1, further comprising the steps of:
adding a device to the network,
said added device identifying the primary device,
said added device requesting (1) the primary device for all available data.

7. A method according to claim 1, wherein the distributed data comprises at least one setting to be distributed between the at least two devices.

8. A method according to claim 7, further comprising the steps of:
removing a device from the network,
the removed device removing all settings not entered by it-self.

9. A method according to claim 7, further comprising the steps of:
removing a device from the network,
the removed device removing all of its settings.

10. A method according to claim 7, wherein each entered setting comprises type information, said type information indicating if a setting shall be distributed, the method further comprising the steps of:
reading said type information,
performing the identifying step, the routing step and the distributing step only if the type information indicates that the setting shall be distributed.

11. A method according to claim 1, wherein the distributed data comprises at least one Uniform Resource Locator (URL) to be distributed between the at least two devices.

12. A method according to claim 1, wherein the data comprises a label identifying the data, and a stamp, the method further comprising the steps of:
each device reading the label and the stamp when receiving the data, and
in case a device receives data having a label-stamp pair in which the label is identical to the label of a label-stamp pair of previously received data, assuming and using the data with the most recent stamp.

13. A method according to claim 12, further comprising the step of removing specific data present in one or more device(s) in response to the device(s) receiving data having a stamp which is indicating that said specific data should be removed.

14. A method according to claim 1, further comprising the step of providing a delay period before the distribution step is performed, said step being initiated by the primary device in response to receiving the data.

15. A network connecting at least two devices, each device being provided with a unique identification, wherein:
a first device of the at least two devices comprises means for receiving data being entered into said first device,
the first device comprises means for identifying a primary device,
the first device comprises means for routing the entered data to said primary device in case said primary device is not the first device, and
the primary device comprises means for distributing the entered data to all of the other of the at least two devices via the network.

16. A network according to claim 1S, wherein at least one of the devices of the network is a Consumer Electronic (CE) device.
